(19) United States
(12) Patent Application Publication
(10) Pub. No.: US 2021/0031732 A1
(43) Pub. Date: Feb. 4, 2021

(54) SENSOR ASSEMBLY WITH CLEANING

(71) Applicant: Ford Global Technologies, LLC, Dearborn, MI (US)

(72) Inventors: SAMI A. ALKHARABSHEH, Dearborn, MI (US); ASHLEY LUCAS, Novi, MI (US); RASHAUN PHINISEE, Ypsilanti Township, MI (US); JENNIFER A. HERR-RATHKE, Plymouth, MI (US); VENKATESH KRISHNAN, Canton, MI (US); RAGHU RAMAN SURINEEDI, Dearborn, MI (US)

(73) Assignee: Ford Global Technologies, LLC, Dearborn, MI (US)

(21) Appl. No.: 16/524,841

(22) Filed: Jul. 29, 2019

(51) Int. Cl. B60S 3/04; B60S 1/56

(52) U.S. Cl. CPC B60S 3/04; B60S 1/56

(57) ABSTRACT

A sensor assembly includes an inlet duct having an elongated inlet segment and an elongated second segment extending upwardly from the elongated inlet segment, a water separator in the elongated second segment, a water drain in the inlet duct below the water separator, and an elbow between the elongated inlet segment and the elongated second segment.

### BACKGROUND

Autonomous vehicles include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices.

### BRIEF DESCRIPTION OF THE DRAWINGS

FIG. 1 is a perspective view of an example vehicle.

FIG. 2 is a perspective view of a sensor assembly of the vehicle.

FIG. 3 is a plan view of the sensor assembly.

FIG. 4 is a side cross-sectional view of the sensor assembly.

### DETAILED DESCRIPTION

A sensor assembly includes an inlet duct having an elongated inlet segment and an elongated second segment extending upwardly from the elongated inlet segment, a water separator in the elongated second segment, and a water drain in the inlet duct below the water separator.

The sensor assembly may further include an elbow between the elongated inlet segment and the elongated second segment, and the elbow may have an angle of greater than or equal to 90° from continuing straight.

The sensor assembly may further include an elbow between the elongated inlet segment and the elongated second segment, and the elbow may have an angle of approximately 90° from continuing straight.

The sensor assembly may further include an elbow between the elongated inlet segment and the elongated second segment, and the water drain may be in the elbow.

The sensor assembly may further include an elbow between the elongated inlet segment and the elongated second segment, and the elongated second segment may be straight and vertical from the elbow to the water separator. The elbow may have a bottom, and the water drain may be in the bottom of the elbow. The elbow may have an angle of approximately 90°.

The water separator may be a mesh of hydrophobic material.

The sensor assembly may further include an image sensor and a housing supporting the image sensor, and the inlet duct may be in the housing. The housing may have an air outlet in fluid communication with the inlet duct, and the air outlet may be aimed at the image sensor. The sensor assembly may further include a fan between the inlet duct and the air outlet. The water separator may be between the fan and the elongated inlet segment.

The housing may have a front face, and the image sensor and an inlet opening of the inlet duct may both be on the front face. The sensor assembly may further include a grille at the inlet opening.

The image sensor may include an illuminator.

The water drain may be positioned to receive water removed from the water separator under the force of gravity.

The sensor assembly may further include an elbow between the elongated inlet segment and the elongated second segment, and the elbow may be configured to collect water droplets in air flowing from the elongated inlet segment to the elongated second segment. The water drain may be positioned to receive water collected in the elbow. The water drain may be positioned to receive water removed by the water separator.

With reference to the Figures, a sensor assembly 32 for a vehicle 30 includes an inlet duct 34 having an elongated inlet segment 36 and an elongated second segment 38 extending upwardly from the elongated inlet segment 36, a water separator 40 in the elongated second segment 38, and a water drain 42 in the inlet duct 34 below the water separator 40.

The sensor assembly 32 can provide an efficiently packaged collection of sensors 44 along with a combined cleaning and cooling apparatus for the sensors 44. The sensor assembly 32 can provide a single mechanism for both cleaning and cooling the sensors 44. The sensor assembly 32 can thus provide a low complexity, a small number of components, and a small volume occupied, i.e., small package size. The sensor assembly 32 provides an interchangeable design that can be located in multiple locations on the vehicle 30.

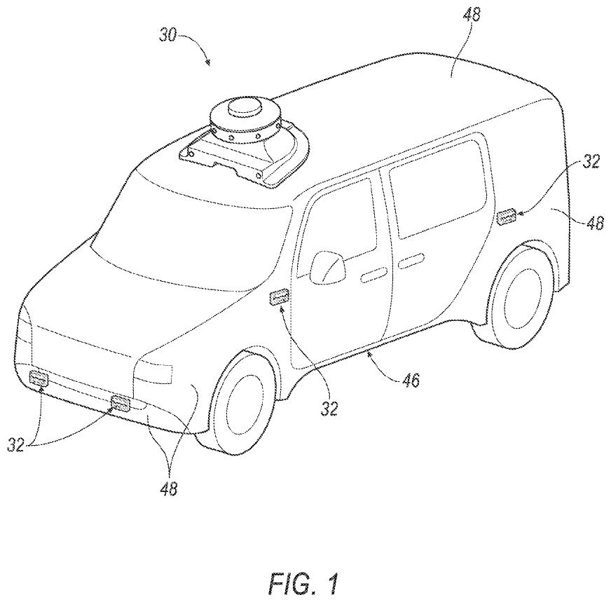

With reference to FIG. 1, the vehicle 30 may be any passenger or commercial automobile such as a car, a truck, a sport utility vehicle, a crossover, a van, a minivan, a taxi, a bus, etc.

The vehicle 30 may be an autonomous vehicle. A computer can be programmed to operate the vehicle 30 independently of the intervention of a human driver, completely or to a lesser degree. The computer may be programmed to operate the propulsion, brake system, steering, and/or other vehicle systems based on data from, e.g., the sensors 44 of the sensor assembly 32. For the purposes of this disclosure, autonomous operation means the computer controls the propulsion, brake system, and steering without input from a human driver; semi-autonomous operation means the computer controls one or two of the propulsion, brake system, and steering and a human driver controls the remainder; and nonautonomous operation means a human driver controls the propulsion, brake system, and steering.

The vehicle 30 includes a body 46. The vehicle 30 may be of a unibody construction, in which a frame and the body 46 of the vehicle 30 are a single component. The vehicle 30 may, alternatively, be of a body-on-frame construction, in which the frame supports the body 46 that is a separate component from the frame. The frame and body 46 may be formed of any suitable material, for example, steel, aluminum, etc. The body 46 includes body panels 48 partially defining an exterior of the vehicle 30. The body panels 48 may present a class-A surface, e.g., a finished surface exposed to view by a customer and free of unaesthetic blemishes and defects.

A housing 50 is disposed on one of the body panels 48. The housing 50 can be attached on an exterior of one of the body panels 48 or can extend through the body panel 48. For example, the housing 50 can be disposed on a front end of the vehicle 30 below a beltline of the vehicle 30, as shown in FIG. 1. While the discussion below is with respect to a single sensor assembly 32, the vehicle 30 can include multiple sensor assemblies 32, each with one housing 50 disposed on one of the body panels 48. The housings 50 can be arranged to provide the respective sensors 44 with a collective field of view entirely around the front end of the vehicle 30.

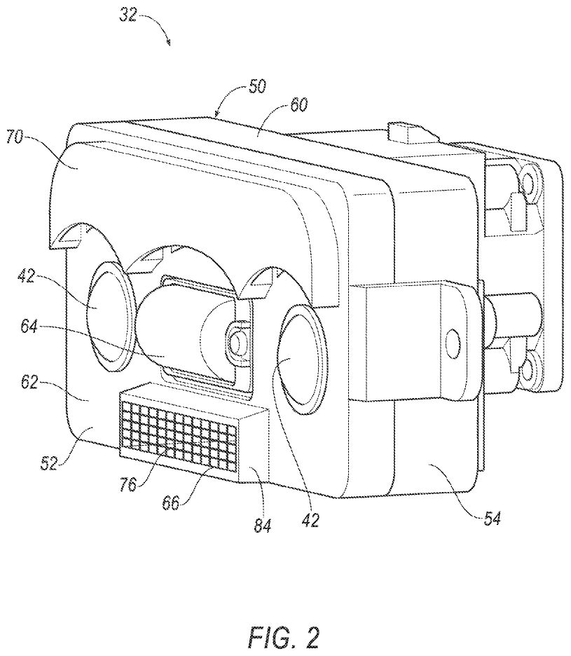

With reference to FIGS. 2-4, the housing 50 includes a front wall 52, two side walls 54, a back wall 56, a floor 58, and a ceiling 60. The walls 52, 54, 56 extend vertically from the floor 58 to the ceiling 60. The walls 52, 54, 56, the floor 58, and the ceiling 60 form an exterior of the housing 50. The front wall 52 has a front face 62 facing away from the body 46 of the vehicle 30, i.e., away the body panel 48 to which the housing 50 is mounted, and the back wall 56 faces toward an interior of the vehicle 30, i.e., toward the body panel 48 to which the housing 50 is mounted, or if the back wall 56 is disposed inside the body panel 48 than away from the body panel 48 toward the interior of the vehicle 30. The side walls 54 extend from the front wall 52 to the back wall 56. The front wall 52 and the back wall 56 each extend from one of the side walls 54 to the other of the side walls 54. The floor 58 and the ceiling 60 are parallel to each other, and the side walls 54 are parallel to each other.

The sensors 44 detect the external world, e.g., objects and/or characteristics of surroundings of the vehicle 30, such as other vehicles, road lane markings, traffic lights and/or signs, pedestrians, etc. For example, the sensors 44 can be radar sensors, scanning laser range finders, light detection and ranging (LIDAR) devices, or image processing sensors such as cameras. In particular, the sensors 44 can be image sensors such as cameras. The sensor assembly 32 can further include an illuminator 64. The illuminator 64 can output light of a wavelength detectable by the sensors 44 to illuminate the environment and make the environment more easily detectable by the sensors 44. For example, the sensors 44 can be infrared cameras, and the illuminator 64 can be an infrared illuminator.

The housing 50 supports the sensors 44 and the illuminator 64. For example, the sensors 44 and the illuminator 64 can be fixedly mounted through the front wall 52, i.e., on the front face 62 facing outward. The fields of view of the sensors 44 extend outward away from the housing 50, i.e., in the direction that the front face 62 faces. The sensors 44 and the illuminator 64 can be disposed on the same horizontal plane. The sensor assembly 32 can include two sensors 44, and the illuminator 64 can be disposed between the two sensors 44.

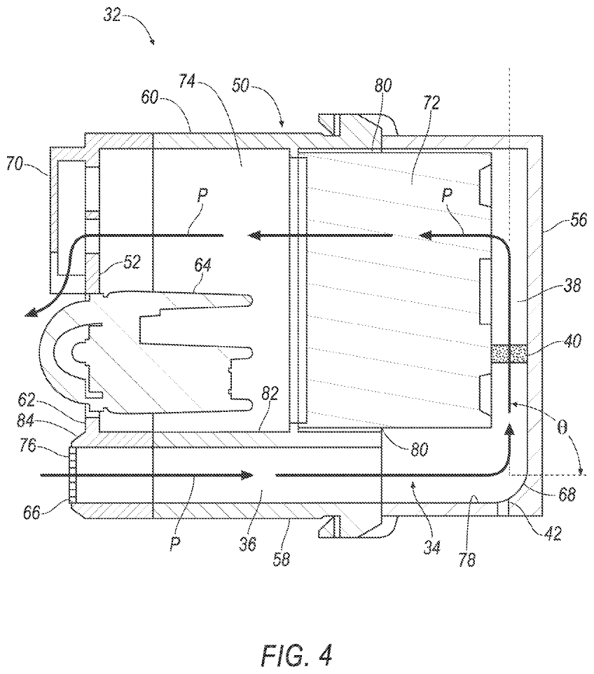

With reference to FIG. 4, the inlet duct 34 is disposed inside the housing 50, and the housing 50 can form part of the inlet duct 34. The inlet duct 34 includes an inlet opening 66, the elongated inlet segment 36, an elbow 68, and the elongated second segment 38. The inlet duct 34 defines part of an airflow path P from the inlet opening 66 to an air outlet 70. The airflow path P extends through, in order, the inlet opening 66, the elongated inlet segment 36, the elbow 68, the elongated second segment 38, a fan 72, an outlet duct 74, and the air outlet 70.

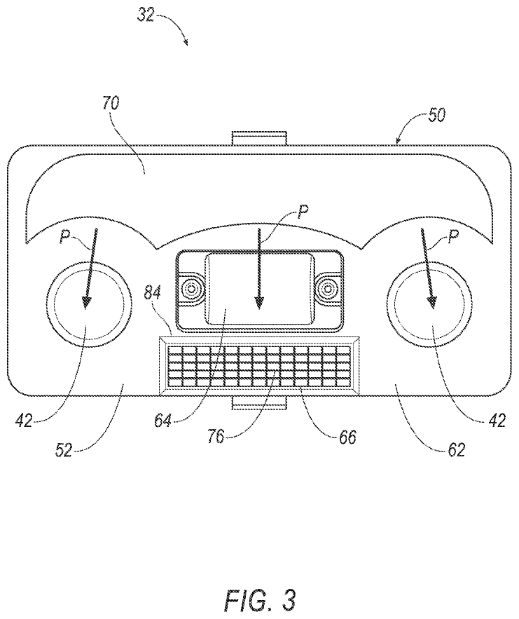

With reference to FIGS. 3 and 4, the inlet opening 66 is on the front face 62, i.e., extends through the front wall 52. The inlet opening 66 can be disposed directly below the illuminator 64. The inlet opening 66 can be disposed below the sensors 44 and directly between the sensors 44 along a horizontal dimension. A grille 76 is disposed at the inlet opening 66 and covers the inlet opening 66. The grille 76 is a mesh of wires spaced apart sufficiently narrowly to prevent solid objects from entering the inlet duct 34; e.g., the wires of the grille 76 can be closer together than a width of a typical insect or a pebble.

With reference to FIG. 4, the elongated inlet segment 36 extends straight from the inlet opening 66 to the elbow 68. The elongated inlet segment 36 has a constant cross-section of constant cross-sectional area from the inlet opening 66 to the elbow 68. The floor 58 of the housing 50 partially forms the elongated inlet segment 36. The elongated inlet segment 36 has a greater length along a direction of airflow through the elongated inlet segment 36 than width or height perpendicular to the direction of airflow.

The elbow 68 extends from the elongated inlet segment 36 to the elongated segment; i.e., the elbow 68 is between the elongated inlet segment 36 and the elongated second segment 38 along the airflow path P. The elbow 68 has a bottom 78 formed by the floor 58 of the housing 50. The elbow 68 has an angle θ of greater than or equal to 90° from continuing straight. In one example, the elbow 68 has an angle θ of approximately 90° from continuing straight, with “approximately” accounting for manufacturing and/or packaging constraints. The angle θ is measured from a straight continuation of the elongated inlet segment 36 to the elongated second segment 38; in other words, the angle θ is between the vector of straight airflow travel through the elongated inlet segment 36 and the vector of straight airflow travel through the elongated second segment 38. The elbow 68 is configured to collect water droplets present in air flowing from the elongated inlet segment 36 to the elongated second segment 38. For example, the angle θ defines a sufficiently sharp turn that some water droplets tend to strike the back wall 56 rather than being able to follow the airflow upward into the elongated second segment 38 because the water droplets have a higher density than the air. In other words, the momentum of the water droplets along the elongated inlet segment 36 carries the water droplets to the back wall 56 as the airflow turns upward into the elongated second segment 38. The water droplets that strike the back wall 56 condense and flow downward to the bottom 78 of the elbow 68.

The elongated second segment 38 extends straight upwardly, i.e., vertically along a straight line, from the elbow 68 to the ceiling 60. The elongated second segment 38 may have a constant cross-section of constant cross-sectional area from the elbow 68 to the ceiling 60. The back wall 56 of the housing 50 partially forms the elongated second segment 38. The elongated second segment 38 is open to the fan 72 on an opposite side of the elongated second segment 38 as the back wall 56. The elongated second segment 38 has a greater length along the vertical direction than width or height perpendicular to the vertical direction.

The water separator 40 is disposed in the elongated second segment 38. The elongated second segment 38 is straight from the elbow 68 to the water separator 40. The water separator 40 is between the elongated inlet segment 36 and the fan 72 along the airflow path P. The water separator 40 is below an opening from the elongated second segment 38 into the fan 72. The water separator 40 extends across an entire cross-section of the elongated second segment 38; i.e., there is no path for air to flow through the elongated second segment 38 and around the water separator 40.

The water separator 40 may be a hydrophobic filter. The water separator 40 may include a mesh of hydrophobic material. The mesh may include a plurality of fibers. The fibers may be continuous fibers and/or short fibers. The fibers may be woven and/or matted. The fibers may be polymeric, e.g., polyester. The fibers may be monolithic. The fibers may repel water and/or may be coated with a coating that repels water. The mesh permits airflow between fibers of the mesh but blocks water droplets and dust from traveling through the mesh. The blocked water droplets flow back down the elongated second segment 38 to the bottom 78 of the elbow 68. As an example, the water separator 40 may of the type commercially available under the tradename Frogzskin from GTL, Inc. in Minnetonka, Minn., USA.

The inlet duct 34 includes the water drain 42. The water drain 42 is positioned to receive water collected in the elbow 68, including water removed by the water separator 40 that flows down the elongated second segment 38 under the force of gravity. In particular, the water drain 42 is in the bottom 78 of the elbow 68 and extends through the floor 58 of the housing 50. The water drain 42 is located directly below the water separator 40.

The fan 72 is between the inlet duct 34 and the air outlet 70 along the airflow path P. The fan 72 is positioned to draw air directly from the elongated second segment 38 and to blow air directly into the outlet duct 74. The fan 72 is an axial fan oriented horizontally. The fan 72 blows air in a direction perpendicular to the direction of airflow through the elongated second segment 38, i.e., perpendicular to the vertical direction along which the elongated second segment 38 is extended. The fan 72 blows air in a direction that is 180° from the direction of the airflow path P through the elongated inlet segment 36.

A shock-absorption member 80 connects the fan 72 to the housing 50. The shock-absorption member 80 is chosen to absorb and dampen vibrations caused by the operation of the fan 72. The shock-absorption member 80 can be a cushioning material such as natural or synthetic rubber.

The outlet duct 74 extends along the airflow path P from the fan 72 to the air outlet 70. The ceiling 60 can partially form the outlet duct 74. An intermediate wall 82 can partially form the outlet duct 74 and partially form the elongated inlet segment 36. The intermediate wall 82 can be a bottom of the outlet duct 74 and a top of the elongated inlet segment 36. Electronics such as the illuminator 64 can be disposed in the outlet duct 74. Air can flow over and thus cool the illuminator 64 and any other electronics in the outlet duct 74.

With reference to FIGS. 3 and 4, the air outlet 70 is mounted on the front face 62 of the housing 50. The air outlet 70 is aimed at the sensors 44 and at the illuminator 64. The air outlet 70 receives air from the outlet duct 74 and directs the air at the sensors 44 and the illuminator 64. The air outlet 70 directs the air along the front face 62 approximately parallel to the front face 62. The airflow across the sensors 44 and the illuminator 64 can block debris from contacting the sensors 44 and the illuminator 64 and can blow debris away from the sensors 44 and the illuminator 64.

An inlet lip 84 extends around the inlet opening 66. The inlet lip 84 extends outward from the front face 62 of the housing 50. For example, the inlet lip 84 can form a bevel raised from the front face 62 and extending around the inlet opening 66 and the grille 76. The inlet lip 84 can help prevent water and debris blown off of the sensors 44 and the illuminator 64 from entering the inlet opening 66. The inlet lip 84 can also help block air exiting the air outlet 70 from recirculating back into the inlet opening 66. The air exiting the air outlet 70 is typically hotter than the air in the ambient environment, so blocking recirculation can better cool the electronics such as the illuminator 64 in the housing 50.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A sensor assembly comprising:
an inlet duct having an elongated inlet segment and an elongated second segment extending upwardly from the elongated inlet segment;
a water separator in the elongated second segment; and
a water drain in the inlet duct below the water separator.

2. The sensor assembly of claim 1, further comprising an elbow between the elongated inlet segment and the elongated second segment, the elbow having an angle of greater than or equal to 90° from continuing straight.

3. The sensor assembly of claim 1, further comprising an elbow between the elongated inlet segment and the elongated second segment, the elbow having an angle of approximately 90° from continuing straight.

4. The sensor assembly of claim 1, further comprising an elbow between the elongated inlet segment and the elongated second segment, the water drain being in the elbow.

5. The sensor assembly of claim 1, further comprising an elbow between the elongated inlet segment and the elongated second segment, the elongated second segment being straight and vertical from the elbow to the water separator.

6. The sensor assembly of claim 5, wherein the elbow has a bottom, and the water drain is in the bottom of the elbow.

7. The sensor assembly of claim 6, wherein the elbow has an angle of approximately 90°.

8. The sensor assembly of claim 1, wherein the water separator is a mesh of hydrophobic material.

9. The sensor assembly of claim 1, further comprising an image sensor and a housing supporting the image sensor, the inlet duct being in the housing.

10. The sensor assembly of claim 9, wherein the housing has an air outlet in fluid communication with the inlet duct, the air outlet being aimed at the image sensor.

11. The sensor assembly of claim 10, further comprising a fan between the inlet duct and the air outlet.

12. The sensor assembly of claim 11, wherein the water separator is between the fan and the elongated inlet segment.

13. The sensor assembly of claim 9, wherein the housing has a front face, the image sensor and an inlet opening of the inlet duct both being on the front face.

14. The sensor assembly of claim 13, further comprising a grille at the inlet opening.

15. The sensor assembly of claim 9, wherein the image sensor includes an illuminator.

16. The sensor assembly of claim 1, wherein the water drain is positioned to receive water removed from the water separator under the force of gravity.

17. The sensor assembly of claim 1, further comprising an elbow between the elongated inlet segment and the elongated second segment, the elbow configured to collect water droplets in air flowing from the elongated inlet segment to the elongated second segment.

18. The sensor assembly of claim 17, wherein the water drain is positioned to receive water collected in the elbow.

19. The sensor assembly of claim 18, wherein the water drain is positioned to receive water removed by the water separator.
